(19) United States
(12) Patent Application Publication
(10) Pub. No.: US 2011/0023794 A1
(43) Pub. Date: Feb. 3, 2011

(54) Retractable Leash Integral with a Dog Collar and Associated Method

(76) Inventor: Sallie Smith, Middlebury, CT (US)

Correspondence Address: Sallie H. Smith, 126 North Street, Middlebury, CT, 06762, US

(21) Appl. No.: 12/843,484

(22) Filed: Jul. 26, 2010

Related U.S. Application Data
(60) Provisional application No. 61/228,990, filed on Jul. 28, 2009.

(51) Int. Cl. A01K 27/00

(52) U.S. Cl. 119/794

(57) ABSTRACT

A dog collar preferably includes an adjustable collar and retractable leash. The retractable leash is preferably located within a housing, whereby the cord is removably attached to the collar and a spring-actuated spool operably mated to the cord. The cord is wound about the spool and maintained at a tensioned position while retracted. Each collar is provided with an id tag that is interchangeable and customized to fit the user's needs.

### CROSS REFERENCE TO RELATED APPLICATIONS

This application references my provisional patent application number U.S. 61/228,990 dated Jul. 28, 2009.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a dog leash and collar and, more particularly, to a retractable leash housed within a dog collar for providing users with a dog collar with a leash attached to it, but which be wound such that the leash does not get in the way when not in use. In addition, the collar can be adapted to meet a variety of fashionable styles and colors.

2. Prior Art

Most dog leashes are purchased separately. Leashes and collars come in many designs and sizes presenting dog owners with a myriad of choices for their pooches. Although convenient and easy to use, very often, these collars and leashes are misplaced and separated from each other presenting their owners with the hassle of having to look for both when it is time to walk their dog. In an addition to this, dog owners who take their dog on boats, trains and automobiles as well has on hikes that allow off leash dogs, this invention will alleviate the possibility of entanglement that could cause strangulation in certain situations.

Also in view the extensive leash laws and ordinances in place under consideration by various municipalities there is a need for an improved leash and collar for domestic animals to ensure they are properly leashed when in public areas. To fulfill these requirements a leash and collar combination having a mechanism to retract and extend the leash combined with the collar to operate as a single unit serves as the best means to afford convenience and safety to busy dog owners who actively take their dogs on daily walking routines and when traveling.

This integrated leash and collar should relieve the dog owner of a search for the leash before each outing; it relieves the owner of attempting to attach the clip on the collar of an excited or impatient animal. It eliminates the problem of storage and availability when not in use. The integrated leash and collar is easily accessible and provides a single hand control of the animal; provides quick availability, affords relief from inconvenient tangling of the leash in boats, cars, dog's legs as well as owners legs which could pose a danger.

This integrated leash and collar can also be worn on dog owners wrist and around their waist by un-clipping the collar and or using an extended belt/collar system. The extended leash with built-in clip will allow the owner to clip the leash to a dog with a regular collar in reverse fashion.

Accordingly, a need remains for an apparatus in order to overcome the above noted shortcomings. The present invention satisfies such a need by providing a retractable leash housed within a dog collar that is convenient and easy to use, lightweight, yet durable in design, versatile in its applications, and designed for providing a user with an effective means of having a stylish dog collar and leash.

### BRIEF SUMMARY OF THE INVENTION

A dog collar preferably includes an adjustable collar and retractable leash. The retractable leash is preferably located within a housing, whereby the cord is removably attached to the collar and a spring-actuated spool operably mated to the cord. The cord is wound about the spool and maintained at a tensioned position while retracted. A button is operably coupled to the spool and releases the spool, when depressed, such that the cord is unwound and automatically extracted from a housing. Each collar is provided with an id tag that is interchangeable and customized to fit the user's needs.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further object and advantages thereof, may best be understood by reference to the following description taken in connection with the accompanying drawings in which the figures generally include various perspective views showing a retractable leash integral with a dog collar.

### DETAILED DESCRIPTION OF THE INVENTION

The present invention will now be described more fully hereinafter with reference to the accompanying drawings, represented as FIGS. 1 through 4, in which a preferred embodiment of the invention is shown. This invention may, however, be embodied in many different forms and should not be construed as limited to the embodiment set forth herein. Rather, this embodiment is provided so that this application will be through and complete, and will fully convey the true scope of the invention to those skilled in the art.

The apparatus of this invention is referred to generally in the figures and is intended to provide a retractable leash housed within a dog collar. It should be understood that the present invention may be used to provide a user with an attractive and fashionable dog collar integral with a leash, to be used with all dog breeds and the like, and should not be limited to the use described herein.

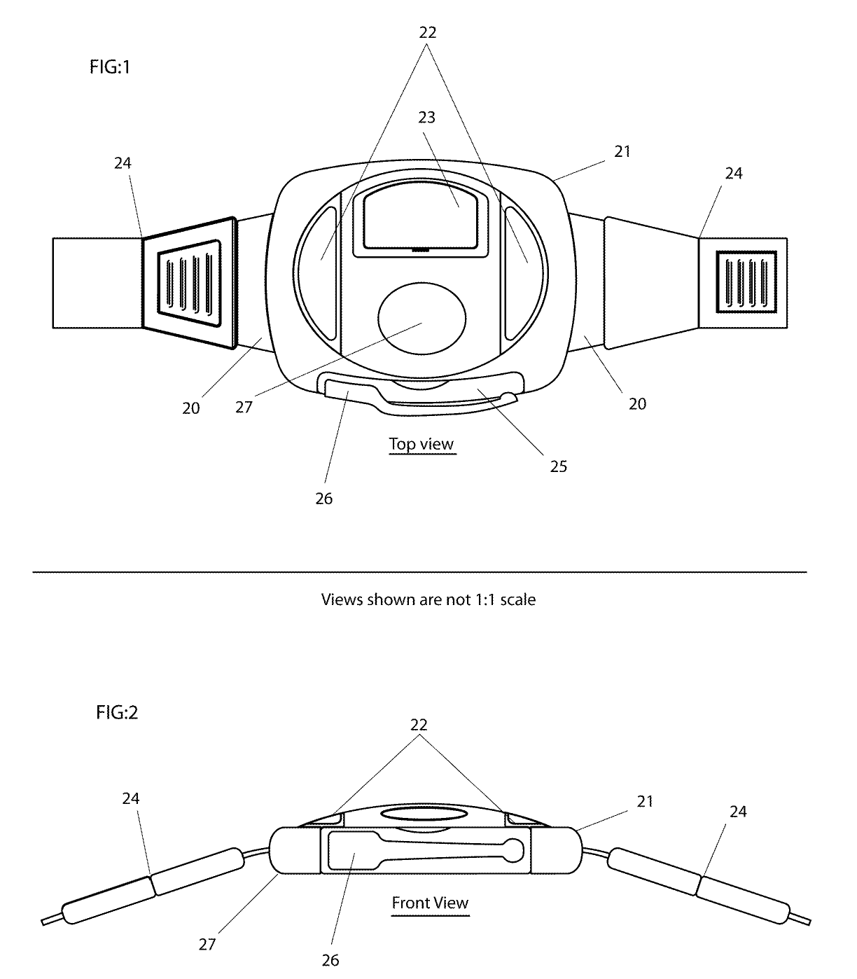

Referring to FIGS. 1 through 4, the retractable leash integral within a dog collar preferably includes an adjustable collar 20 (FIGS. 1 and 4) and retractable leash housing 21 (FIGS. 1, 2 3 and 4) with the possibility of containing reflectors 22 (FIGS. 1, 2 and 4), id tag 23 (FIGS. 1 and 4), and is able to carry a computer chip and small battery for a GPS locations device.

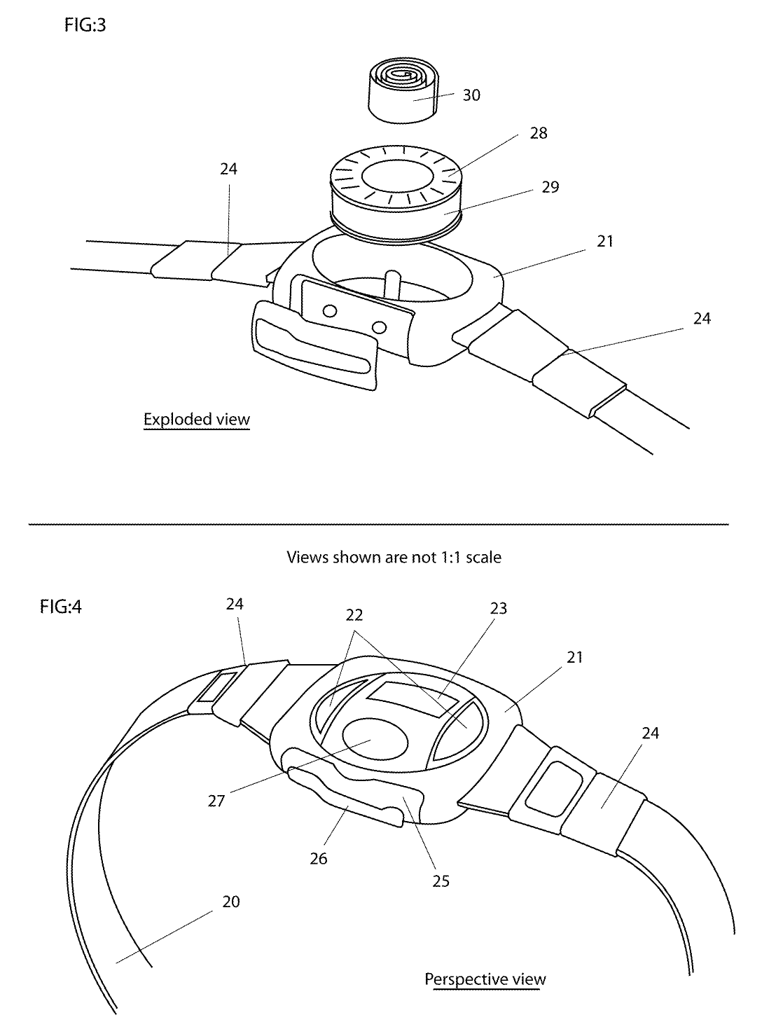

The retractable leash housing 21 (FIGS. 1, 2 3 and 4) is attached to the collar by means of male and female buckles 24 (FIGS. 1, 2, 3 and 4). The leash handle 25 (FIGS. 1 and 4) with belt clip 26 (FIGS. 1, 2 and 4) pulls away from the retractable leash for quick access for leashing the animal. The button 27 (FIGS. 1, 2 and 4) can be pushed to engage the rewinding mechanism 28 (FIG. 3) to retract the leash material 29 (FIG. 3) and handle/belt clip 25/26 (FIGS. 1 and 4).

The retractable leash housing 21 (FIGS. 1, 2 3 and 4) can be removed from the collar 20 (FIGS. 1 and 4) and self attached around users wrist or users belt for reverse leashing. Clip 26 (FIGS. 1, 2 and 4) then can be used on any dog collar. The interior mechanism for the retractable leash comprises a revolving spindle 28 (FIG. 3) that houses the leash material 29 (FIG. 3). A metal coil spring 30 (FIG. 3) is used to retract the leash 29 (FIG. 3) when the button 27 (FIGS. 1, 2 and 4) is engaged.

The adjustable collar 20 (FIGS. 1 and 4) may be manufactured of any durable yet lightweight material as would be obvious to one skilled in the art. The retractable leash 29 (FIG. 3) is located within a retractable leash housing 21 (FIGS. 1, 2 3 and 4), where the leash 29 (FIG. 3) is wound about the spool and maintained at a tensioned position while retracted. A button 27 (FIGS. 1, 2 and 4) is operably coupled to the spool and thereby releases the spool, when depressed, such that the leash material 29 (FIG. 3) is unwound and automatically extracted from the retractable leash housing 21 (FIGS. 1, 2 3 and 4) shielding the spool therein.

In use, the retractable leash integral within a dog collar would be simple and straightforward to use. First, the user would choose a collar 20 (FIGS. 1 and 4) that best suits the taste of the user and their dog. The user would then attach the collar 20 (FIGS. 1 and 4) around the dog's neck. The retractable leash material 29 (FIG. 3) can be expelled from the housing 21 (FIGS. 1, 2 3 and 4) by activating the button 27 (FIGS. 1, 2 and 4), if necessary to control the dog. When the leash 29 (FIG. 3) is no longer needed the button can be activated again to retract the leash 29 (FIG. 3) into the housing 21 (FIGS. 1, 2 3 and 4).

The apparatus features id tags 23 (FIGS. 1 and 4) that can be customized as the user wishes. For example, a user may wish to have the pet's name and the owner's phone number and address printed on the id tag 23 (FIGS. 1 and 4). In this manner, if a dog is lost, the owners can be contacted, and the pet can be returned. Notably, each collar 20 (FIGS. 1 and 4) is provided with an id tag 23 (FIGS. 1 and 4) that is interchangeable and thereby customized to fit the user's needs.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A dog collar with a retractable leash for providing users with a dog collar integral with a leash such that the leash can be wound so that it is not in the way when not in use. In addition, the collar can be adapted to meet a variety of fashionable styles and colors.
